(19) United States
(12) Patent Application Publication
(10) Pub. No.: US 2012/0004741 A1
(43) Pub. Date: Jan. 5, 2012

(54) PROCESS CONTROL SYSTEM HAVING EQUIPMENT MONITORING FUNCTION

(75) Inventor: Shin Suzuki, Tokyo (JP)

(73) Assignee: YAMATAKE CORPORATION, Tokyo (JP)

(21) Appl. No.: 13/171,763

(22) Filed: Jun. 29, 2011

(30) Foreign Application Priority Data
Jun. 30, 2010 (JP) 2010-149834

(51) Int. Cl. G05B 11/01

(52) U.S. Cl. 700/12

(57) ABSTRACT

HART-I/O units for sending and receiving input/output signals of HART communications-compatible devices that have HART communications functions, and for sending and receiving, on mutually differing lines, 4-20 mA DC signals, which include the input/output signals, and digital signals that are superimposed on the DC signals. A controller for receiving a DC current that is outputted from the HART-I/O units and for controlling processes based on the DC signals; and a device monitoring portion for receiving digital signals sent and received by the HART-I/O units, and for monitoring the status of the HART communications-compatible devices based on the digital signals.

### CROSS REFERENCE TO RELATED APPLICATIONS

The present application claims priority under 35 U.S.C. §119 to Japanese Patent Application No. 2010-149834, filed Jun. 30, 2010, which is incorporated herein by reference.

### FIELD OF TECHNOLOGY

The present invention relates to a process control system having a function for monitoring a field device that is equipped in a plant.

### BACKGROUND OF THE INVENTION

In the field of manufacturing process control, various types of field devices having communication functions (for example, sensors, valves, and the like) are installed in the plants, to control the various manufacturing processes in the plants through reading into a system signals that are transmitted from the field devices. As systems that control manufacturing processes there are those that control, for example, the degree of opening of valves based on flow rates, temperatures, pressures, and the like, read in from sensors. In recent years, devices equipped with HART (Highway Addressable Remote Transducer) communication functions have been used as field devices connected to this type of process control system. HART communication-compatible devices perform input and output of signals (hereinafter termed “HART communication signals”) that are produced by superimposing digital signals, which have been converted into frequency signals of 1200 Hz or 2200 Hz, onto DC signals of between 4 and 20 mA, that indicate the measured values or control values. That is, HART communication-compatible devices are able to apply and exchange various types of information, in addition to measured values and control values. Systems that use HART communication-compatible devices are disclosed in Japanese Unexamined Patent Application Publication 2003-186503 (“JP '503”) in Japanese Patent 4129715 (“JP '715”), below.

In the systems of JP '503 and JP '715 referenced above, the HART communications signals are used by controllers and by the communications buses that transmit process signals. Typically, communications buses and controllers have high process capabilities that are adequately fast to handle the process signals. However, in order to enable high-speed HART communications signals, in addition to process signal communication, requires replacement with even higher speed communication buses between the HART communication-compatible equipment and the controllers, and also requires the controllers to be replaced with controllers with high processing capabilities. However, replacing the communications buses and controllers requires tremendous cost.

The present invention was created in order to solve the problems in the conventional technology described above, and the object thereof is to provide a process control system that enables restructuring of the system at a relatively low cost, even when using field devices equipped with HART communications functions.

### SUMMARY OF THE INVENTION

The process monitoring system according to the present invention includes an input/output device for sending and receiving input/output signals of a field device having a HART communications function, and for sending and receiving, on respectively differing lines, first signals that are included in the input/output signals and second signals that are superimposed on the first signals; a controlling portion for receiving a first signal, outputted from the input/output device, and for controlling a process based on the first signal; and a monitoring portion for receiving a second signal that is sent and received by the input/output device, and for monitoring the state of a field device based on the second signal.

The use of the structure makes it possible to control the higher-level side of the input/output device that sends and receives the input/output signals of the field devices, by dividing into a control system for controlling processes and a monitoring system for monitoring the status of the field devices. That is, it enables a separate provision and independent control of a control system and a monitoring system. Consequently, even when additionally device monitoring functions, for example, are added to an existing system wherein there is only a control system, this makes it possible to add the device monitoring functions without having a negative impact on the existing system. Moreover, the device monitoring functions can be added smoothly and easily, because of the ability to use the equipment of existing system control system (for example, the wiring and terminals thereof) without modification.

The first signal may be a 4-20 mA DC signal, and the second signal is a frequency signal wherein a digital signal has been converted. Additionally, the second signal may include a value corresponding to the first signal.

The present invention enables the provision of a process control system wherein a system can be restructured at a relatively low cost even if using field devices that are equipped with HART communications functions.

### BRIEF DESCRIPTION OF THE DRAWINGS

FIG. 1 is a diagram illustrating schematically the structure of a process control system according to an example.

FIG. 2 is a diagram illustrating schematically an example of a structure of a network that uses a ring Ethernet™ system.

FIG. 3 is a diagram illustrating schematically an example of a structure of a network that uses a ring Ethernet™ system.

### DETAILED DESCRIPTION OF THE PRESENT INVENTION

An example according to the present invention is explained below in reference to the drawings. However, the example explained below is no more than an illustration, and does not exclude various modifications and applications to technologies not explicated below. That is, the present invention can be embodied in a variety of modified forms, in the scope that does not deviate from the spirit and intent thereof.

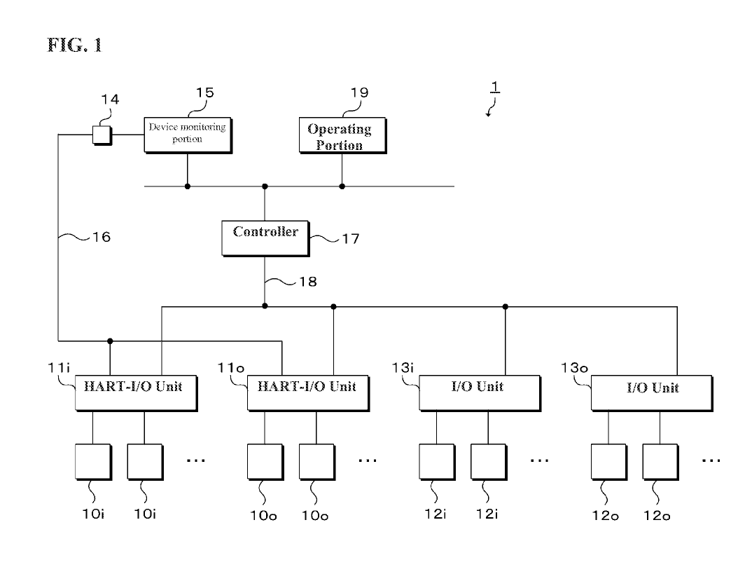

First the structure of the process control system in the present example is explained in reference to FIG. 1. As illustrated in FIG. 1, the process control system 1 has HART communications-compatible devices 10i and 10o; HART-I/O units 11i and 11o, which are input/output devices having HART communications functions; field devices 12i and 12o; I/O units 13i and 13o; a hub 14; a device monitoring portion 15; a controller 17; and an operating portion 19.

The controller 17 and the operating portion 19, which are provided on the higher-level side than the HART-I/O units 11i and 11o and the I/O units 13i and 13o, structure the control system for controlling the process. On the other hand, the hub 14 and the device monitoring portion 15, which are provided on the higher-level side than the HART-I/O units 11i and 11o, structure the system for monitoring the status, etc., of the HART communications-compatible devices 10i and 10o.

A low-speed communications bus 18, for example, is connected between the controller 17 and the HART-I/O units 11i and 11o and I/O units 13i and 13o that structure the control system. An Ethernet™-standard communications cable 16 is connected between the hub 14 and the HART-I/O units 11i and 11o that structure the monitoring system.

Various types of sensors such as flow rate sensors, pressure sensors, and temperature sensors can be used as the HART communications-compatible devices 10i and field devices 12i.

Valves such as flow rate controlling valves and pressure controlling valves, where actuators such as pumps and fans, for example, can be used as the HART communications-compatible devices 10o and field devices 12o/The HART communications-compatible devices 10i and 10o are field devices wherein HART communications functions are provided, and perform input/output of HART communications signals. HART communications signals are signals that are produced by superimposing, onto 4-20 mA DC signals, digital signals that are converted into frequency signals of 1200 Hz and 2200 Hz.

The DC signal is a signal that has a value that is one variable that is set for each HART communications-compatible device for each field device. The variable value is a measurement value such as, for example, a flow rate, a pressure, or a temperature, or a control value such as a degree of valve opening. The digital signals are signals indicating various types of data that can be collected with in the HART communications-compatible devices. As the various types of data there are, for example, process data in the HART communications-compatible device, or failure data for hardware included in the HART communications-compatible device. Note that measurement values and control values of the HART communications-compatible device may also be included in the various types of data.

The HART communications-compatible devices 10i and 10o produce HART communications signals as described below, for example. First, the HART communications-compatible devices 10i and 10o convert digital signals that are expressed as 0 and 1 are converted into frequency signals that are expressed as 2200 Hz signals and 1200 Hz signals. Following this, the HART communications-compatible devices 10i and 10o superimpose the converted frequency signals onto 4-20 mA DC signals that represent measured values or control values, or the like. The HART communications signals are produced thereby.

The HART-I/O units 11i and 11o are input and output devices that send and receive the HART communications signals, and send and receive 4-20 mA DC signals and digital signals, respectively. The HART-I/O units 11i and 11o generate the 4-20 mA DC signals and digital signals from the HART communications signals as described below, for example. First the HART-I/O units 11i and 11o separate the received HART communications signal into a frequency signal, expressed by a 1200 Hz signal and a 2200 Hz signal, and a 4-20 mA DC signal. Following this, the HART-I/O units 11i and 11o convert the separated frequency signal into a digital signal.

The field devices 12i and 12o are field devices that do not have the HART communications functions, and input and output the 4-20 mA DC signals that represent measured values or control values, or the like. The I/O units 13i and 13o are input/output devices that send and receive the 4 to 20 mA DC signals.

The device monitoring portion 15 receives, through the hub 14, the digital signals outputted from the HART-I/O units 11i and 11o. The device monitoring portion 15, based on the digital signals received, performs diagnoses of the state of execution of processes in the HART communications-compatible devices, the states of failures in the hardware that is included in the HART communications-compatible devices, times wherein maintenance and repair are required in the HART communications-compatible devices, and the like. The device monitoring portion 15 displays the diagnostic results, and the like, on a monitor. Doing so enables the operator to monitor the HART communications-compatible devices.

The controller 17 controls the status of execution of the manufacturing process through controlling the HART communications-compatible devices 10i and 10o, and the field devices 12i and 12o. Specifically, the controller 17 adjusts the opening of valves, and the like, through controlling the HART communications-compatible device 10o or field device 12o, based on a measured value such as a flow rate, a pressure, or the like, received from the HART communications-compatible device 10i or field device 12i, for example.

The operating portion 19 displays the operating detail of the HART communications-compatible devices 10i and field devices 12i on a monitor screen, based on the 4 to 20 mA DC signals received from the controller 17.

Doing so enables the operator to understand the details of operation of the HART communications-compatible devices 10i and field devices 12i. The operating portion 19 controls the operating states of the HART communications-compatible devices 10i and 10o and field devices 12i and 12o in accordance with operating instructions from the operator. The operating detail of the operating status may be, for example, an operation for starting-up a device or an operation for shutting-down a device.

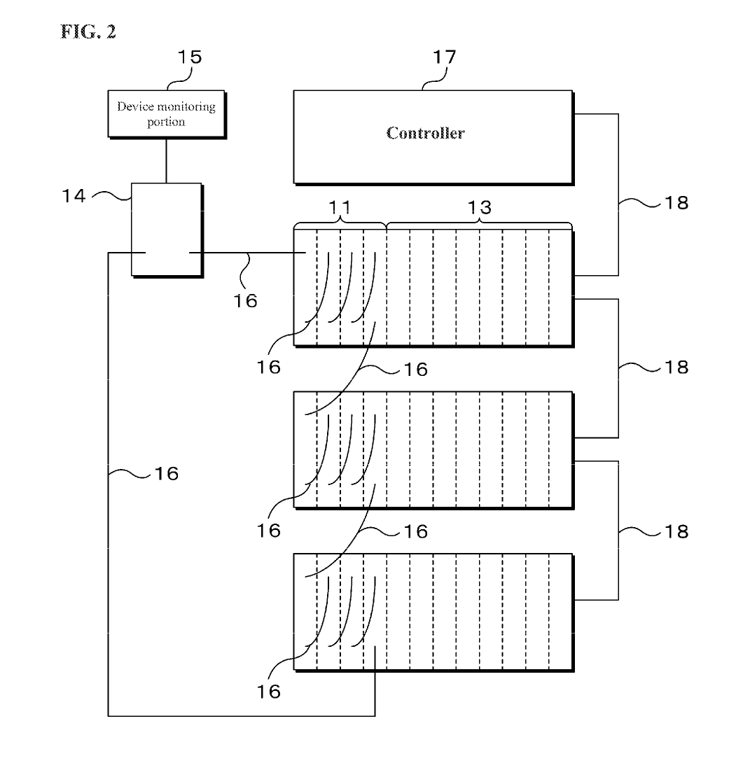

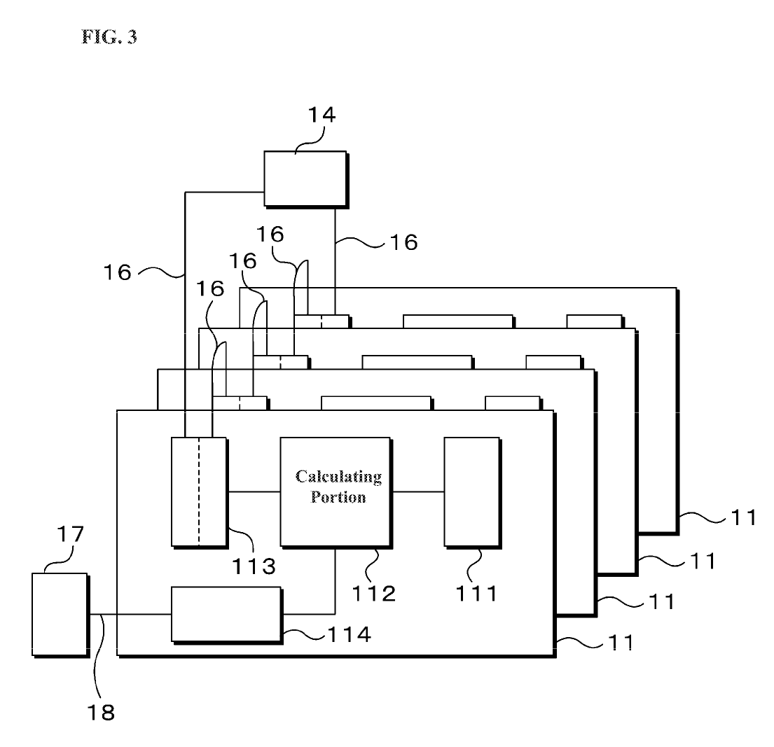

The process control system 1 can structure a network using, for example, a ring-type Ethernet™ system. FIG. 2 and FIG. 3 illustrates schematically an example of a structure of a network that uses a ring Ethernet™ system. In FIG. 2 and FIG. 3, Ethernet™ standard communication cables are used to connect, in a ring topology, between the hub 14 and various HART communications-compatible devices 10 that structure the process control system 1. Structuring the network using the ring topology enables the communications with the other devices to be maintained even if for example, there were a failure in one of the devices (modules) within the network or if the connector for one of the devices were removed for maintenance. Note that 111 in FIG. 3 is an input/output interface between the HART communications-compatible devices 11i and 10o, 113 is an Ethernet™, and 114 is an input/output interface between controllers 17, 112 is a calculating portion for performing various types of calculations.

Structuring of the process control system 1 as set forth above enables monitoring functions for the field devices 12i and 12o to be added easily. An example of the procedure is described below.

First, the field devices 12i and 12o are replaced by HART communications-compatible devices 10, and the I/O units 13i and 13o are replaced by HART-I/O units 11.

Following this, the connector for the communications bus that is connected to the controller 17 and the connector for the communications cable 16 that is connected to the hub 14 on the device monitoring portion 15 side are inserted into the respective communications ports on the higher-level side of the HART-I/O unit 11, after replacement.

Adding the device monitoring function in this way makes it possible to add a device monitoring function while using, as is, the existing control system equipment (for example, the communications bus 18, controller 17, and operating portion 19).

As described above, the process control system 1 according to the present example enables the higher-level side of the HART-I/O unit 11 to be controlled divided into a control system that controls the processes and a monitoring system that monitors the status is of the HART communications-compatible devices 10. That is, it enables a separate provision and independent control of a control system and a monitoring system.

Consequently, even when additionally device monitoring functions, for example, are added to an existing system wherein there is only a control system, this makes it possible to add the device monitoring functions without having a negative impact on the existing system.

Moreover, the device monitoring functions can be added smoothly, because of the ability to use the existing system control system (for example, the wiring and terminals thereof) without modification.

1. A process control system comprising:
an input/output device sending and receiving input/output signals of a field device having a HART communications function, and sending and receiving, on respectively differing lines, first signals that are included in the input/output signals and second signals that are superimposed on the first signals;
a controlling portion receiving a first signal, outputted from the input/output device, and controlling a process based on the first signal; and
a monitoring portion receiving a second signal that is sent and received by the input/output device, and monitoring the state of a field device based on the second signal.

2. The process control system as set forth in claim 1, comprising:
the first signal is a 4-20 mA DC signal, and the second signal is a frequency signal wherein a digital signal has been converted.

3. The process control system as set forth in claim 1, comprising:
the second signal includes a value corresponding to the first signal.
